(19) United States
(12) Patent Application Publication
(10) Pub. No.: US 2008/0216141 A1
(43) Pub. Date: Sep. 4, 2008

(54) ON DEMAND RF VIDEO FEED FOR PORTABLE VIDEO MONITOR

(75) Inventors: Christopher J. Long, Los Alamitos, CA (US); David Eric Shanks, Los Angeles, CA (US)

Correspondence Address: THE DIRECTV GROUP, INC.;PATENT DOCKET ADMINISTRATION, CA / LA1 / A109, 2230 E. IMPERIAL HIGHWAY, EL SEGUNDO, CA, 90245, US

(73) Assignee: THE DIRECTV GROUP, INC., El Segundo, CA (US)

(21) Appl. No.: 12/026,747

(22) Filed: Feb. 6, 2008

Related U.S. Application Data
(60) Provisional application No. 60/888,663, filed on Feb. 7, 2007.

(51) Int. Cl. H04N 7/173

(52) U.S. Cl. 725/114

(57) ABSTRACT

The present invention discloses systems for selectively viewing video information. A system in accordance with the present invention comprises a portable monitor, a video router, and a controller, coupled to the video router, wherein the video router selectively sends requested video information to the portable monitor based on commands from the controller.

### CROSS-REFERENCE TO RELATED APPLICATIONS

This application claims the benefit under 35 U.S.C Section 119(e) of U.S. Provisional Application Ser. No. 60/888,663, filed on Feb. 7, 2007, by Christopher J. Long et al., entitled “ON-DEMAND RF VIDEO FEED FOR PORTABLE VIDEO MONITOR,” which application is incorporated by reference herein.

### BACKGROUND OF THE INVENTION

1. Field of the Invention

The present invention relates generally to video systems, and in particular, to a method, apparatus, and article of manufacture for delivering a radio frequency (RF) video feed to a portable video monitor.

2. Description of the Related Art

Video production of live events, such as sporting events, is widely used throughout many genres. Camera operators are stationed at various places around a given venue, and are given instructions from producers and directors to follow certain parts of the action. One camera follows a general plot line, e.g., the overall view of a given event, and other cameras may follow specific actors or players, based on the live unfolding of events.

Further, there are subplots that occur within each of the events, e.g., two rivals going head-to-head, which may be just as important as the final score to some viewers. Many times a camera is trained on the star participants, or, throughout the contest, cameras can be focused on the head-to-head matchup, depending on the desires and needs of the producer and production crew.

There are times that the action in a live event needs to be replayed, both for the general viewing audience as well as for participants. For example, instant replay in sporting events assists both fans and officials to get a call correct on a given play, etc. However, such replays are typically only available system wide, to viewers that record the event on a Personal Video Recorder (PVR) or the like, and only upon direction from the producer or director. Further, such replays are typically only available for a limited amount of time before the director moves on to another camera shot.

It can be seen, then, that there is a need in the art for ways to access replay material for an extended period of time. It can also be seen that there is a need in the art to provide on-demand access to previously recorded material on a private channel.

### SUMMARY OF THE INVENTION

To minimize the limitations in the prior art, and to minimize other limitations that will become apparent upon reading and understanding the present specification, the present invention discloses systems for selectively viewing video information. A system in accordance with the present invention comprises a portable monitor, a video router, and a controller, coupled to the video router, wherein the video router selectively sends requested video information to the portable monitor based on commands from the controller.

Such a system further optionally includes the video router selectively sending requested video information based on a request from a viewer of the portable monitor, the requested video information being sent from the video router to the portable monitor via a radio frequency (RF) link, access to the RF link being controlled, a recorder, coupled to the video router, and the requested video information being stored on the recorder.

An apparatus for viewing a recorded video stream in accordance with the present invention comprises a monitor, and a receiver, coupled to the monitor, wherein the receiver receives the recorded video stream via a radio frequency signal generated by a video router, wherein the receiver receives the recorded video stream based on a request from the receiver.

Such an apparatus further optionally comprises the receiver only receiving a video signal when the receiver is localized to a given range from the video router, the receiver must register with the video router to receive the recorded video stream, a first receiver being granted access to a first subset of available recorded video streams, and a second receiver being granted access to a second subset of available recorded video streams, and a third receiver being granted access to all available recorded video streams.

Other features and advantages are inherent in the system disclosed or will become apparent to those skilled in the art from the following detailed description and its accompanying drawings.

### BRIEF DESCRIPTION OF THE DRAWINGS

Referring now to the drawings in which like reference numbers represent corresponding parts throughout:

FIG. 1 illustrates a typical satellite television installation, used in conjunction with the present invention; and

FIG. 2 illustrates a typical video camera feedback system in accordance with the present invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

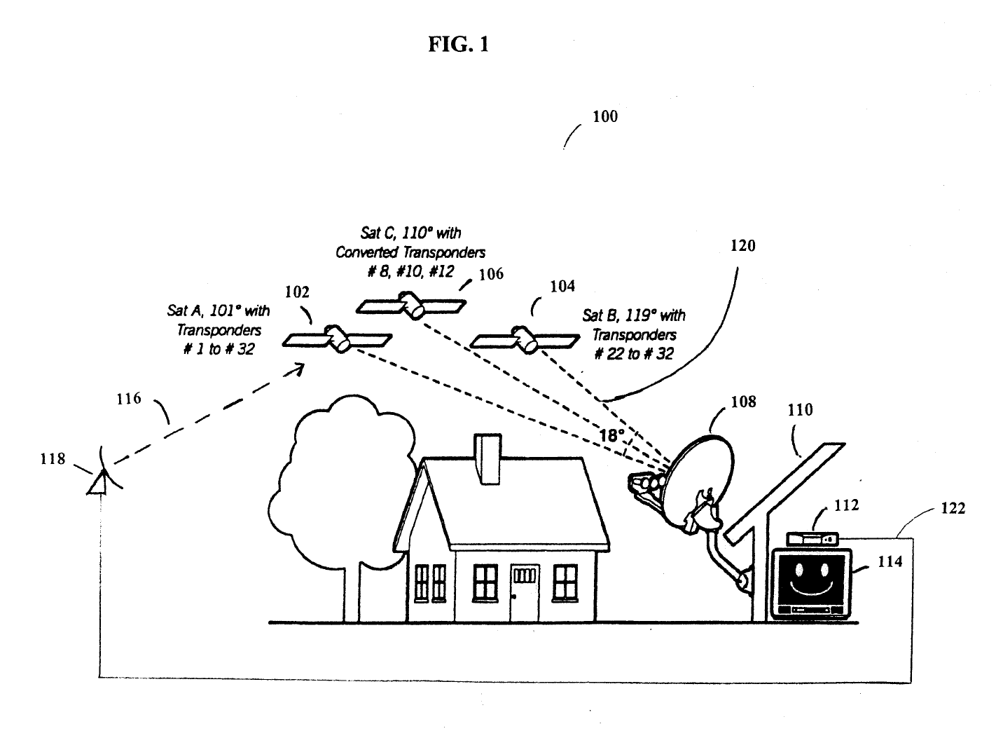

FIG. 1 illustrates a typical satellite television installation of the related art.

System 100 uses signals sent from Satellite A (SatA) 102, Satellite B (SatB) 104, and Satellite C (SatC) 106 that are directly broadcast to an Outdoor Unit (ODU) 108 that is typically attached to the outside of a house 110. ODU 108 receives these signals and sends the received signals to IRD 112, which decodes the signals and separates the signals into viewer channels, which are then passed to monitor 114 for viewing by a user. There can be more than one satellite transmitting from each orbital location and additional orbital locations without departing from the scope of the present invention.

Satellite uplink signals 116 are transmitted by one or more uplink facilities 118 to the satellites 102-106 that are typically in geosynchronous orbit. Satellites 102-106 amplify and rebroadcast the uplink signals 116, through transponders located on the satellite, as downlink signals 120. Depending on the satellite 102-106 antenna pattern, the downlink signals 120 are directed towards geographic areas for reception by the ODU 108.

Alternatively, uplink facilities 118 can send signals via cable 122 either in conjunction with uplink signals 116 or instead of uplink signals 116 to IRD 112, for display on monitor 114.

Each satellite 102-106 broadcasts downlink signals 120 in typically thirty-two (32) different frequencies, which are licensed to various users for broadcasting of programming, which can be audio, video, or data signals, or any combination. These signals are typically located in the Ku-band of frequencies, i.e., 11-18 GHz, or in the Ka-band of frequencies, i.e., 18-40 GHz, but typically 20-30 GHz.

### Video Control System

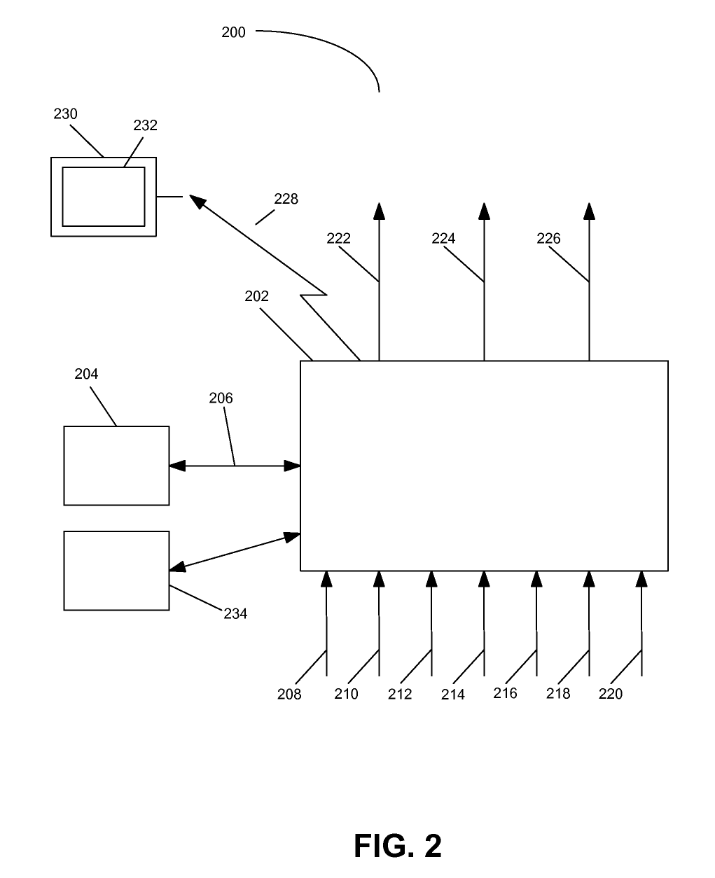

FIG. 2 illustrates an embodiment of a video control system in accordance with the present invention.

System 200 comprises a video router 202 and a controller 204. Controller 204 communicates with video router 202 via cable 206. Typically, controller 204 is a personal computer or other microprocessor controlled device, and can be coupled to video router 202 via cable, fiber optic connection, or via radio frequency or internet access as desired.

Video router 202 accepts as inputs various video inputs 208-220. A larger or smaller number of video inputs 208-220 can be used by video router 204 without departing from the scope of the present invention. Through control commands sent to video router 202 from controller 204, various composite video outputs 222-226, i.e., mosaic channel outputs 222-226, are generated by video router 204. Typically, system 200 is contained in a trailer or other room located near where the video inputs 208-220 are being used; however, such geographical proximity is not required.

Video router 202 is used to transport video inputs 208-220, either alone or in combination, to the video outputs 222-226. Typically, routers are described by the number of inputs by the number of outputs, e.g., a four input, ten output router 202 would be called a 4×10 router. The type of video signals transported by router 202 can be anything from analog composite signals, e.g., Phase Alternating Line (PAL) signals, National Television Systems Committee (NTSC) signals, to signal components such as Serial Digital Interface (SDI) signals, High-Definition SDI (HD-SDI) signals, etc. Broadband types of video routers 202 can route more than one signal type, e.g., SDI and HD-SDI signals, simultaneously.

Any of the inputs 208-220 of video router 202 can be transported to any of the video outputs 222-226. The internal arrangement of the video router 202 is typically arranged as a series of crossover points that are selectively activated or deactivated to block or pass a given input 208-220 to a given output 222-226. These crossover points are typically controlled by external switches and/or software to activate/deactivate a given crossover point, which control is typically provided by controller 304.

The video router 202 in combination with controller 204, allows a producer or director of a given viewer channel to control what is being seen on that channel by controlling which video inputs 208-220, alone or in combination, that are being broadcast on one of the outputs 222-226, and thus, the content of a given viewer channel. Controller 204 further controls the appearance, layout, and additional items that appear on a given video channel, such as a control bar, the placement of video cells, and the video input or inputs 222-26 that appear in a given video cell.

The various composite video outputs 222-226 can all be directed to different viewer channels if desired; however, it is within the scope of the present invention to send the various composite video components 222-226 to the same viewer channel in sequential order based on commands received from the controller 204. This control of a single video channel allows for automated control of video input to a given viewer channel, and, as such, allows for rapid change in viewer channel display of information through computer control (i.e., controller 204) of the viewer channel presentation.

One or more of the video outputs 222-226 can be used as a localized video distribution, e.g., a closed-circuit video distribution, if desired. Further, one or more of the video outputs can be combined into a Radio Frequency (RF) signal 228, which can be selectively output by controller 204 from video router 202. Receiver 230, which includes monitor 232, receives signal 228 and displays the RF signal 228 for viewing. Alternatively, receiver 230 can be hardwired to router 202 to receive one or more of the video outputs 222-226.

Receiver 230 can be a specialized receiver 230, but can also be a portable personal computer, e.g., a laptop with a wireless networking card installed. Receiver 230 can receive signal 228 via a registration process with system 200, such that only certain receivers 230 can receive signal 228 even though many receivers 230 are within range of video router 202. For example, and not by way of limitation, some receivers 230 may only receive certain video from video router 202, while other receivers 230 receive all of the signals 228 that come from router 202. Such an arrangement may be useful to allow different teams to see selected video outputs 222-226 via signal 228, while officials or administrative personnel can see all of the video inputs 208-220, as well as any recorded video from recorder 232.

Such a system 200 allows for an instant viewing of a specific video output 222-226, or, if desired, multiple video outputs 222-226, as well as previously recorded video from recorder 234, which may record one or more of the video inputs 208-220 during the event. This allows for specific localized viewing of any video information in real time.

For example, and not by way of limitation, a review of a specific play or event can be requested for localized viewing on monitor 232. In a football game, for example, the video outputs 222-226 that are sent to a monitor 114 via system 100 are determined by the producer of that specific game; the video outputs 222-226 that are reviewed by the referee are requested by the referee on a specific monitor. The present invention allows, for example, a coach to request a given video output 222-226, or the recorded version of one or more video inputs 208-220, on a personal monitor 228 that can be carried by the coach or the coaches' assistant. The coach can make a request for a specific video input 208-220 that has a good angle on the play, and review the play before making a challenge, rather than relying on any public address system or other inputs before deciding on challenging a given call or play.

Another example would be in a NASCAR race, where one driver is bumped or otherwise feels interfered with from another driver. The driver's crew chief can request a video replay of the incident, which came from video inputs 208-220 and recorded on recorder 234, and have it ready for the driver to review prior to confronting the alleged offender.

### CONCLUSION

The present invention discloses systems for selectively viewing video information. A system in accordance with the present invention comprises a portable monitor, a video router, and a controller, coupled to the video router, wherein the video router selectively sends requested video information to the portable monitor based on commands from the controller.

Such a system further optionally includes the video router selectively sending requested video information based on a request from a viewer of the portable monitor, the requested video information being sent from the video router to the portable monitor via a radio frequency (RF) link, access to the RF link being controlled, a recorder, coupled to the video router, and the requested video information being stored on the recorder.

An apparatus for viewing a recorded video stream in accordance with the present invention comprises a monitor, and a receiver, coupled to the monitor, wherein the receiver receives the recorded video stream via a radio frequency signal generated by a video router, wherein the receiver receives the recorded video stream based on a request from the receiver.

Such an apparatus further optionally comprises the receiver only receiving a video signal when the receiver is localized to a given range from the video router, the receiver must register with the video router to receive the recorded video stream, a first receiver being granted access to a first subset of available recorded video streams, and a second receiver being granted access to a second subset of available recorded video streams, and a third receiver being granted access to all available recorded video streams.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but by the claims appended hereto and the full range of equivalents to the claims appended hereto.

What is claimed is:

1. A system for selectively viewing video information, comprising:
a portable monitor;
a video router; and
a controller, coupled to the video router, wherein the video router selectively sends requested video information to the portable monitor based on commands from the controller.

2. The system of claim 1, wherein the video router selectively sends requested video information based on a request from a viewer of the portable monitor.

3. The system of claim 1, wherein the requested video information is sent from the video router to the portable monitor via a radio frequency (RF) link.

4. The system of claim 1, wherein access to the RF link is controlled.

5. The system of claim 1, further comprising a recorder, coupled to the video router.

6. The system of claim 5, wherein the requested video information is stored on the recorder.

7. An apparatus for viewing a recorded video stream, comprising:
a monitor, and
a receiver, coupled to the monitor, wherein the receiver receives the recorded video stream via a radio frequency signal generated by a video router, wherein the receiver receives the recorded video stream based on a request from the receiver.

8. The apparatus of claim 7, wherein the receiver only receives a video signal when the receiver is localized to a given range from the video router.

9. The apparatus of claim 8, wherein the receiver must register with the video router to receive the recorded video stream.

10. The apparatus of claim 9, wherein a first receiver is granted access to a first subset of available recorded video streams, and a second receiver is granted access to a second subset of available recorded video streams.

11. The apparatus of claim 10, wherein a third receiver is granted access to all available recorded video streams.
